(19) United States
(12) Patent Application Publication
(10) Pub. No.: US 2026/0093472 A1
(43) Pub. Date: Apr. 2, 2026

(54) DISTRIBUTED NETWORK WITH ROBUST FAULT INDICATION CONTAINMENT AND SOFTWARE REVISION CONTROL METHOD

(71) Applicant: GM GLOBAL TECHNOLOGY OPERATIONS LLC, Detroit, MI (US)

(72) Inventors: Anthony J. Sumcad, Rochester Hills, MI (US); Eric T. Hosey, Rochester Hills, MI (US); Suchinder K. Govindan, Farmington Hills, MI (US); David Adams, Troy, MI (US); Russell A. Patenaude, Macomb Township, MI (US)

(73) Assignee: GM GLOBAL TECHNOLOGY OPERATIONS LLC, Detroit, MI (US)

(21) Appl. No.: 18/903,431

(22) Filed: Oct. 1, 2024

(51) Int. Cl. G06F 8/65

(52) U.S. Cl. CPC G06F 8/65

(57) ABSTRACT

A distributed network system includes a back office server and a population of one or more host systems, e.g., vehicles. A first telematics network of the back office server includes a remote calibration tool. Each host system includes a second telematics network having an electronic control unit (ECU) operable for communicating with the back office server. The host systems also include one or more devices controlled by corresponding software code. The back office server is configured, in response to a configuration signal, to transmit an over-the-air (OTA) software update to a predetermined one or more of the host systems. The ECU is configured, in response to the OTA software update, to selectively mask or unmask a software partition of the corresponding software code to respectively disable or enable a function of the one or more devices.

### INTRODUCTION

The present disclosure relates to automated systems and methods for proactively implementing software updates, calibrations, and possible fault codes. Mobile and stationary host systems of various types incorporate increasing amounts of complex electronics and software, updates for which are sometimes required. On board a vehicle for instance, the software used to control vehicle systems and components such as powertrain systems, battery systems, power electronics, air bags, anti-lock braking systems, and navigation/infotainment systems may at times require calibrations or updates. For instance, previously loaded software may be updated whenever improvements or corrections are made or new software versions are released. These adjustments, which may occur automatically via the internet or another suitable network connection as over-the-air (OTA) updates, are intended to maintain proper vehicle functionality.

OTA updates in a representative vehicle application typically occur automatically in the background without affecting current function. Such downloads pause as needed based on network connectivity, download size, and other factors. Software updates are later installed when the vehicle is idle, typically when the vehicle is parked and not otherwise in operation. In this manner, OTA updates and revision changes are largely transparent and unobtrusive. However, existing approaches for updating host systems of a networked population of host systems may be suboptimal in certain respects, for instance when updating or calibrating software of individual vehicles during manufacturing, transportation to a dealership, sale, or post-sale customer use.

### SUMMARY

Disclosed herein are systems and methods for providing robust fault indication containment and software revision control aboard a host system within a distributed network. The host system is exemplified herein as a vehicle having a telematics control platform, the latter of which is referred to hereinbelow as an electronic control unit (ECU) for simplicity. The approach described below enables over-the-air (OTA) control of software calibrations and updates, along with possible control of customer-visible fault indicators such as diagnostic trouble codes (DTC) where needed. Vehicle functionality is proactively and intelligently corrected by the ECU via remote automatic identification, classification, and adjustments to software parameters. In the non-limiting vehicle implementations, the disclosed solutions eliminate the need to manually recognize and individually configure vehicle populations in a vehicle-by-vehicle manner, thereby reducing instances of human error, recording of false trouble modes, and unnecessary dealership repair visits.

In particular, a distributed network is disclosed herein that includes (1) a node in the form of a back office server, and (2) one or more nodes in the form of a population of host systems in wireless communication with the back office server. The back office server includes a first telematics network having a remote calibration tool. The host systems each include a respective second telematics network. Each second telematics network in turn includes an ECU operable for communicating with the back office server, and one or more devices controlled by corresponding software code. The back office server in this embodiment is configured, e.g., in response to receiving a configuration signal, to transmit an OTA software update to a predetermined one or more of the host systems. The ECU responds to the OTA software update by selectively masking off or unmasking a software partition of the corresponding software code to respectively disable or enable a function of the one or more devices.

The ECU may, in response to the OTA software update, temporarily disable a diagnostic trouble code (DTC) associated with the function of the one or more devices. The ECU in one or more implementations may also determine a confidence score indicative of a likelihood of the OTA software update having corrected a fault in the corresponding software code, and may unmask the software partition when the confidence score exceeds a confidence threshold.

The ECU in one or more embodiments may also compare a flag in the OTA software update to a flag in the software partition to determine whether the OTA update is directed to correcting a fault in the software partition. The ECU may thereafter unmask the software partition when the flag in the OTA software update matches the flag in the software partition. The ECU may additionally upload a set of host system updates to the back office, with the set of host system updates including an updated status of the software partition.

Embodiments of the back office server described herein may include a graphical use interface (GUI) as part of its first telematics network. In such a construction, the remote calibration tool is accessible to a user of the back office server via the GUI.

The ECU may be configured, in response to the OTA software update including an updated software version, to selectively unmask the software partition of the corresponding software code to enable the function of the one or more devices. The ECU of each respective host system may be identically configured, with the back office server for its part configured to transmit the OTA software update to a subset of the host systems in the population of host systems based on the configuration signal.

A method is also disclosed herein for use with a distributed network system. According to an embodiment, and in response to a configuration signal, the method may include transmitting an OTA software update to one or more of host systems. This occurs via a back office server, with the back office server having a first telematics network that includes a remote calibration tool. The method includes selectively disabling or enabling a function of the one or more devices of a host system in response to the OTA software update. This may include selectively masking off or unmasking a software partition of a corresponding software code via an ECU of a second telematics network of a host system. The second telematics network is in wireless communication with the first telematics network of the back office.

Also disclosed herein is a vehicle in communication with a back office server in a distributed network, in this instance a vehicle network or population of vehicles. The vehicle includes an ECU operable for communicating with the back office server via a telematics network of the vehicle. The vehicle also includes one or more vehicle devices controlled by corresponding software code. The ECU in this embodiment is configured to receive an OTA software update from the back office server. In response to the OTA software update from the back office server, the ECU selectively masks or unmasks a software partition of the corresponding software code to respectively disable or enable a function of the one or more vehicle devices. This action may include temporarily disabling or enabling a DTC associated with the function of the one or more vehicle devices.

The above and other features and advantages of this disclosure will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a distributed network having a back office server and a population of host systems, the latter of which are configured with containment and software revision control functions as set forth herein.

FIG. 2 is a block diagram of a representative telematics system usable aboard each of the host systems of FIG. 1.

FIG. 3 is a flow chart illustrating a method for performing containment and software revision control in accordance with an embodiment.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

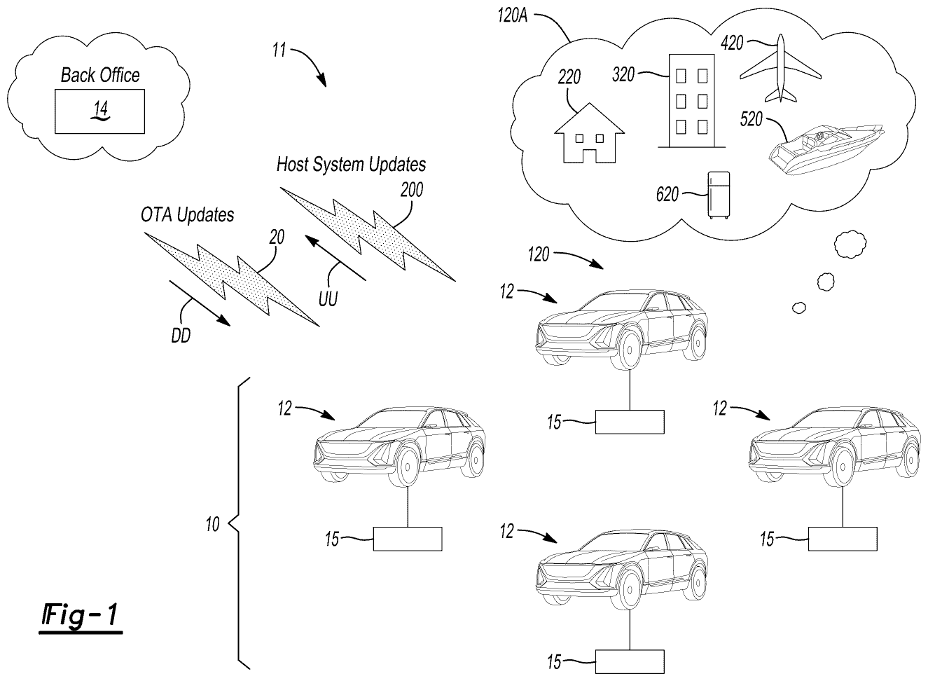

Referring to the drawings, wherein like reference numbers refer to like features throughout the several views, FIG. 1 illustrates a population 10 of host systems 120 in networked communication with an offboard application or cloud computing service referred to hereinafter as a back office server 14. The various host systems 120 and the back office server 14 together form computer-based communication nodes of a distributed network system 11. In the various non-limiting embodiments described below with reference to FIGS. 1-3, the host systems 120 are configured as vehicles 12, for instance passenger vehicles as shown in FIG. 1, or trucks, work vehicles, farm vehicles, etc. Alternative host systems 120A may include residential homes 220, sales offices, manufacturing, or factory buildings 320, aircraft 420, boats 520, appliances 620, and the like. The vehicles 12 will be described hereinafter solely for illustrative consistency, and thus without limiting the present disclosure to mobile or vehicular applications.

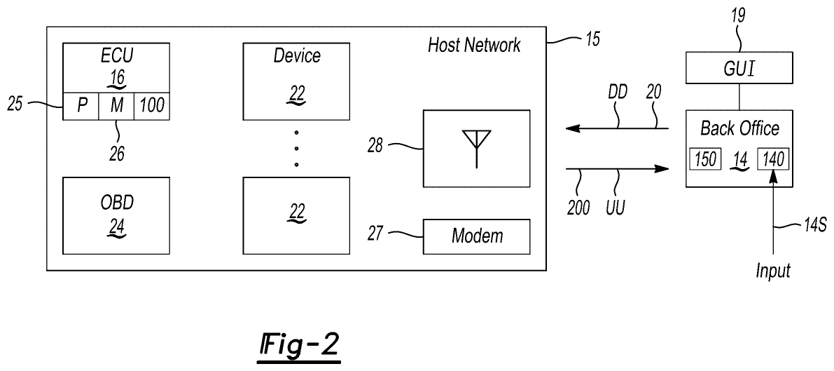

For each of the vehicles 12 shown in FIG. 1, make-specific and model-specific vehicle software may be downloaded or updated during the vehicle's operating life, e.g., in the factory building 320 during manufacturing, during transport of the vehicle 12 to a point of sale, at a point of repair, or anytime the vehicle 12 is in the customer's use. Software may be updated as a full replacement, a revision change, or a removal of portions of previously loaded software. In some implementations, the software may involve machine-readable code that is executable by corresponding electronic control units (ECUs) 16 (FIG. 2) of a given vehicle 12. Other software components may involve calibration, configuration, and/or performance information, manifests, infotainment systems catalogs, and the like, which in turn may be used to control a function of one or more vehicle devices 22 (FIG. 2) located onboard the vehicle 12.

In particular, over-the-air (OTA) updates 20 are transmitted by and ultimately downloaded (arrow DD) from the back office server 14 allow manufacturers of the vehicles 12 to apply the OTA software updates 20 remotely/from a distance of potentially hundreds of kilometers or more, thus allowing owners/operators of the vehicles 12 to avoid unnecessary dealership repair visits. Each vehicle 12 in turn may selectively communicate OTA system updates 200 to the back office server 14 in accordance with aspects of the disclosure as described below. The OTA updates 200 in this case are uploads propagating in a direction opposite the downloads from the back office server 14, and thus are indicated in FIG. 1 by arrow UU for added clarity.

Referring briefly to FIG. 2, a telematics host network 15 including the ECU 16 acts as a primary wireless communication hub for the vehicle 12, with each vehicle 12 having its own telematics host network 15 as represented in FIG. 1. Functions are enabled using a cellular modem 27, a Wi-Fi module, and other network modules such as a transceiver 28. The host network 15 is programmed to collect data from a host of different onboard vehicle devices 22, e.g., engines, electric traction motors, battery systems, power inverter modules, etc., along with components, subcomponents, sensors, navigation systems, infotainments systems, and other possible devices (not shown). The host network 15 thus enables remote diagnostics and performance of the OTA software updates 20 noted above, along with the various advantages of the present onboard solutions.

Onboard a modern vehicle such as the vehicles 12 illustrated in FIGS. 1, 5-digit alphanumeric codes referred to as Diagnostic Trouble Codes or DTCs are automatically recorded in response to a detected malfunction or failure. The faults are autodetected by an Onboard Diagnostic (OBD) system 24 during operation of the vehicle 12. DTCs may be read using a handheld scanner (not shown) by connecting the scanner to an OBD-II port (not shown) located in or on the vehicle 12, such as under a dashboard or behind a steering column. Each DTC uniquely identifies the particular system experiencing the fault, such as the powertrain, chassis, air conditioning, communications network, etc., along with an associated fault. Use of DTCs thus facilitates diagnosis of a myriad of possible vehicle faults. Such faults may at times occur in portions of the above-noted vehicle software.

The telematics host network 15 of the representative vehicles 12 of FIG. 1 are in remote communication with the back office server 14, also referred to in the art as a Vehicle Communications Services (VCS). The back office server 14, possibly using configuration signals 14S from a remote calibration tool 140 as described below, pushes the OTA software updates 20 to various the vehicles 12 as needed. That is, each respective one of the vehicles 12 may receive the same updates, different updates, or no updates depending on decisions made by the back office server 14 as described below. As appreciated in the art, the back office server 14, for example ONSTAR®, includes associated infrastructure for managing, distributing, and monitoring the OTA software updates provided via the OTA software updates 20.

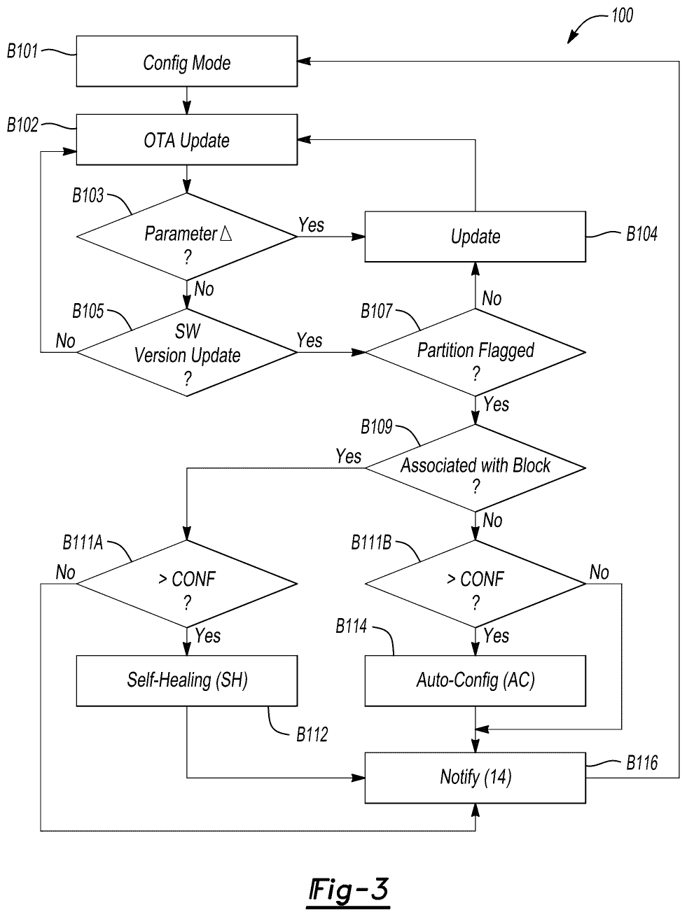

Absent the present solutions, the OTA software updates 20 would normally be pushed to the vehicles 12 based on a given set of vehicle identification numbers (VINs), and thereafter would maintain records of the software update records for each of the vehicles 12. An operations team using the back office server 14 in such a case would manually track the updates on a vehicle-by-vehicle basis. In the present approach, many of the tasks of controlling the OTA software updates 20 are offloaded to the vehicle 12 and its resident ECU 16 for self-application using the method 100 described below with reference to FIG. 3.

Although omitted from FIG. 2 for simplicity, each vehicle 12 of FIG. 1 may also be equipped with hardware components to facilitate operation of the telematics functions needed herein, including but not limited to an electronic video display device, a microphone, audio speakers, and assorted user input controls such as buttons, knobs, pedals, switches, touchpads, and/or touchscreens. A network connection interface enables such hardware to send and receive electronic messages and signals with one another and with various systems both onboard and off-board the vehicle to allow the vehicle 12 to perform assorted vehicle functions, e.g., powertrain control, Advanced Driver Assistance System (ADAS) functions, battery management functions, etc. Wireless communication may be performed according to one or more wireless protocols, such as the IEEE 802.11 protocols, Worldwide Interoperability for Microwave Access (WiMAX), and/or BLUETOOTH™.

The telematics host network 15 and its resident ECU 16 may be generally composed of one or more processors (P) 25, each of which may be embodied as a discrete microprocessor, an application specific integrated circuit (ASIC), or a dedicated control module. Instructions embodying a method 100, a non-limiting example of which is shown in FIG. 3, may be stored in tangible, non-transitory computer-readable storage medium or memory (M) 26 and executed by the processor(s) 25 to perform the described indication containment and software revision functions described below. Such memory 26 may include, for example, CD-ROM, magnetic disk, optical memory, solid-state drive (SSD) memory, hard-disk drive memory, flash memory, semiconductor memory (e.g., various types of RAM or ROM), etc.

REPRESENTATIVE OPERATING SCENARIO: the present approach as described below with reference to FIG. 3 may be best understood using a hypothetical example. For the representative population 10 of vehicles 12 shown in FIG. 1, the fielded ECUs 16 (FIG. 2) thereof may have previously loaded various software versions and/or calibrations. In other words, each one of the vehicle 12 may have different software versions/calibrations. As a manufacturer builds different vehicle platforms, newer model years, etc., the manufacturer follows a software development process during which software developers might discover various issues or make/model-specific faults. The vehicles 12 may start with a common/same set of software, but changes/calibrations may start to proliferate.

For a particular model of vehicle in the population 10 of vehicles 12 shown in FIG. 1, a given manufacturer may discover that a particular software issue arises in model year (MY) 2023 vehicles 12 of nominal Model #1 and MY 2024 vehicles 12 of nominal Model #2. The remaining vehicles 12 in the population 10 in this instance do not have the same issues. A possible reason for this might be that Models #1 and #2 are performance vehicles able to pull high gravitational forces that might not have been contemplated or reached before. For other vehicles 12 having the same ECU 16 of FIG. 2 but perhaps a different MY and a non-performance model, operation of the software might not pose a problem, even using the same software calibrations. As a result, and using the present method 100, the manufacturer could calibrate different software features or mask different faults for Models #1 and #2 in this illustrative example, while the software in the remaining vehicles 12 remains unaltered. Eventually, the manufacturer may update the software over-the-air using the OTA software updates 20 of FIGS. 1 and 2 so that Models #1 and #2 will no longer experience the issues.

Selective re-enablement of software features, faults, etc., is likewise enabled by the method 100. Three options exist for accomplishing this goal: (1) the software loaded on the vehicle 12; (2) an application in the back office server 14, i.e., the remote calibration tool 140 of FIG. 2, which as contemplated herein is able to calibrate the software and/or turn software faults on or off; and (3) another application via the remote calibration tool 140 of the back office server 14, one configured to reflash the software on the vehicle 12 by downloading software packages, e.g., version revisions, as part of the OTA software updates 20 of FIGS. 1 and 2.

Keeping with the above example, the present approach may entail using the remote calibration tool 140 of the back office server 14 of FIG. 2 to identify vehicles 12 of MY 2023 Model #1 and MY2204 Model #2 having a particular software issue, bug, or unexpected result. Affected software in these vehicles 12 is then calibrated off (turned off or masked) in response to the configuration signals 14S. The flexibility of identifying affected vehicles 12 via the remote calibration tool 140 enables a user of the back office server 14 to state via the configuration signals 14S a preference for calibrating, e.g., MY 2023 and/or MY 2024 vehicles 12, or more narrowly Models #1 and #2 from those model years, or simply vehicles 12 having a particular ECU 16 and software set. The same tool would enable the user of the back office server 14 to flexibility request calibration of a certain generation of the telematics host network 15 (FIG. 2), again via the configuration signals 14S.

To that end, the remote calibration tool 140 may be implemented as a graphical user interface (GUI) 19 to a back office network 150, i.e., one configured similarly to the telematics host network 15, and thus equipped with a similar ECU 16, modem 27, and transceiver 28. To the vehicles 12 in the population 10 of FIG. 1, therefore, the back office server 14 and its resident back office network 150 may appear as another node in a wireless network, albeit one having the designated functions provided by the remote calibration tool 140 as described below.

Once the targeted problematic software has been masked in this manner, the back office server 14 may also be used to update the existing software, including possibly masked partitions thereof with new software. This may be achieved in one of two ways. First, a user of the back office server 14 may track when the vehicles 12 are updated via the OTA software updates 20 and then, using the same remote calibration tool 140, communicate with the vehicles 12 to reverse the prior software calibration/masking effort. However, this may be relatively difficult to achieve due to the need to synchronize different applications of the back office server 14 for ensuing years. Second, the back office server 14 may place flags or identifiers in different partitions of the loaded software, and a corresponding flag/multiple flags in the OTA software update 20. If the ECU 16 of FIG. 2 sees the corresponding flag(s) in the OTA software update 20 and the flag(s) match those in the current software partition, the ECU 16 may recalibrate the partition to how the partition was originally constructed. This feature allows the user of the back office server 14 to let the OTA software updates 20 occur over time, with the vehicles 12 automatically restoring the original state the developers envisioned prior to manifestation of the software issues. Similarly, the present approach would allow the flags to be omitted from the OTA software updates 20, and thus the calibrations to remain in place, when the particular OTA software updates 20 do not repair the software issue.

Referring now to FIG. 3, the method 100 noted above is organized into constituent code segments or logic blocks for illustrative clarity. Each block may be executed by the processor(s) of FIG. 1 to perform the described functions. In general, the ECUs 16 of FIG. 2 are individually operable for communicating remotely with the back office server 14 when performing the method 100. In one or more embodiments, each ECU 16 and associated hardware/software of the telematics host network 15 is configured to execute instructions from the memory 26 via the processor 25 during operation of the vehicle 12. A similar approach may be followed for other host systems 120, 120A.

Execution of the instructions causes the ECU 16 to receive the OTA software update 20 from the back office server 14. As noted above, the OTA software update 20 is configured to update a function of one of the electronically-controlled vehicle systems 22 of FIG. 2, and may be a calibration or a full software update/revision change, with the nature of the OTA software update 20 being determined by the users of the back office server 14 as noted above. The ECU 16 may determine whether software partitions or functions associated with the vehicle 12 and the OTA update 20 were previously masked off. The ECU 16 may also determine a “confidence score” indicative of a software fault and possible corresponding DTC being corrected by the OTA software update 20, e.g., using sensor data or other criteria, then selectively restore functions of the impacted vehicle system(s) 22 when the confidence score exceeds a confidence threshold.

In the particular embodiment of the method 100 shown in FIG. 3, and beginning with block B101 (“Config Mode”), the ECU 16 of FIG. 1 for a corresponding one of the vehicles 12 and/or the back office server 14 of FIG. 1 initiates an automatic configuration monitoring mode during which the ECU 16 is permitted to monitor resident software for changes in response to receipt of the OTA software update 20 from the back office server 14. As part of block B101, the ECU 16 may initiate the self-monitoring of software partitions for changes. Such software partitions as contemplated herein are segments of software code associated with one or more functions aboard the vehicle 12, e.g., operation of one or more of the vehicle systems 22 described above. In Configuration Monitor Mode, the ECU 16 of FIG. 2 may observe the following for changes relative to a baseline/previously loaded software: block partitions, software versions, and associated bit mappings, e.g., DTCs, system IDS (SIDS), feature IDS (FIDS), etc. As appreciated in the art, the OTA software update 20 and thus its contents are determined by users of the back office server 14 via the configuration signals 14S to the remote calibration tool 140 (see FIG. 2). The method 100 proceeds to block B102 while monitoring for changes during the OTA software update 20.

At block B102 (“OTA Update”), the ECU 16 may next initialize tables and functional mapping. As part of block B102, the ECU 16 may verify the initial state of the vehicle 12 with respect to a table of its functions. For example, assuming a plurality of N software partitions of such code, each of the N partitions may be mapped to different software parameters and system functions, for instance in one or more lookup tables. The ECU 16 thus associates each piece of software code with a given function aboard the vehicle 12.

During block B102, the ECU 16 may observe variances or “deltas” in, e.g., software versions, bit settings, or other relevant software parameters. In other words, (i) software is originally preloaded into memory 26 of the ECU 16 of FIG. 2 or other memory locations, for instance factory default software or dealership loaded, (ii) the software is arranged in the plurality (N) of software partitions, with each software partition associated with one or more onboard functions such as display settings, powertrain control settings, radio functions, airbag setting, and the like, and (iii) the ECU 16 monitors the software partitions for partition-specific changes that might be contained in the OTA software updates 20 from the back office server 14 of FIG. 1. The method 100 proceeds to block B103 as observation is ongoing.

Block B103 (“Parameter Δ”) entails determining if the ECU 16 has observed a parameter change in the OTA software update 20. As the ECU 16 is aware of existing software characteristics of previously loaded software, the ECU 16 is able to examine each of the various software partitions for changes from this baseline. The method 100 proceeds to block B104 when the ECU 16 determines that one or more software parameters have changed. The method 100 proceeds in the alternative to block B105 when the ECU 16 fails to observe such a parameter change.

At block B104 (“Update”), the ECU 16 next updates the monitored parameters with a corresponding status, conditions of the change(s), and other relevant information. Block B104 may entail turning off or masking software in one or more software partitions as noted above. When this occurs, such partitions may be demarcated or “flagged”, e.g., with a corresponding bit, bit string, or other identifier indicating that the partition was masked off. The method 100 then returns to block B102.

At block B105 (“SW Version Update?”), the ECU 16 of FIG. 2 next determines whether a software version has been updated. As appreciated in the art, software versions are unique identifiers of a specific release/iteration of a software component. Software versions are typically sequentially numbered, e.g., Version 1.0, 1.1, or 1.1.2 indicating a software version (1) and its current iteration (0, 1.1, 1.2). In the same example, an OTA software update 20 may communicate Version 2.0, which would be an entirely new version that would replace previously-loaded “Version 1” software in this instance. The method 100 returns to block B102 when the ECU 16 fails to observe such a software version change, and to block B107 in the alternative when a software version change has been observed.

Block B107 (“Partition Flagged?”) of FIG. 3 entails determining whether a software partition has been flagged, e.g., as having changed in some manner at block B105. For instance, the ECU 16 may record a bit code in memory 26 when a software partition has changed due to a version update. Block B107 in that case may include examining the recorded bit code against a predetermined value indicative of the changed status. The method 100 thereafter proceeds to block B109.

At block B109 (“Associated with Block?”), the ECU 16 of FIG. 1 next begins the processes of repairing issues that may be present in the existing software block/partition. Block B109 entails determining whether the flagged software partition is associated with a block of code in the OTA software update 20. As part of block B109, therefore, the ECU 16 may compare the received OTA software update 20 to existing code to determine whether a parameter of the received software is associated with the flagged partition or software block from block B107 of method 100. As noted above, exemplary parameters may include a SIDS, FIDS, or another feature or functions of the vehicle 12. The method 100 proceeds to block B111A if the parameter is associated with flagged software of block B107, and to analogous block B111B in the alternative.

Block B111A (“<CONF?”) includes determining if the parameter(s) at block B109 are above a confidence threshold. As contemplated herein, the confidence threshold may include a predetermined set of conditions or values associated with the parameter(s) from block B109. In general, the ECU 16 determines (in the event the confidence threshold is exceeded) that it may be safe to turn on certain functions. Other examples may include, e.g., emergency functions or functions having a higher priority. In this case, the method 100 proceeds to block B112.

Block B111B (“>CONF?”) is analogous to block B111A and includes determining if the parameter(s) of the flagged partition of block B107, which are not associated with the parameters of block B109, are nevertheless above the noted confidence threshold. The confidence threshold may include a predetermined set of conditions or values associated with the parameter(s) from block B107 as noted above in the description of block B111A. The method 100 thereafter proceeds to block B114.

Block B112 (“Self-Healing (SH)”) includes the ECU 16 entering a “Self-Healing” mode. During the SH mode, the ECU 16 of FIG. 2 may trigger actions to correct improper or temporary values upon their detection. Thus, to some degree the ECU 16 is able to restore previously masked off software partition and associated functionality, including possibly reenabling DTCs that, previously, were erroneous but which may now be valid in view of the OTA software updates 20 As part of block B112, the SH mode may enable selectively toggling or control of customer-visible error indicators aboard the vehicle 12. The method 100 thereafter proceeds to block B116.

Block B114 (“Auto-Config (AC)”) includes entering an “Automatic Configuration” mode. In such a mode, the ECU 16 of FIG. 2, rather than performing self-healing actions to restore previously masked off software functions as in block B112, instead identifies the presence of new functionality by the flagged block of code (B107) and the presence of unconfigured settings. The method 100 thereafter proceeds to block B116.

At block B116 (“Notify (14)”), the ECU 16 notifies the back office server 14 of FIGS. 1 and 2 of the present parameter status, updates a stored copy or “digital twin”, and possibly suggests possible corrective actions. Block B116 may entail selectively communicating a set of updated software parameters to the back office server 14 as the host system updates 200 of FIG. 1, via the ECU 16, upon installing the OTA software update 20. The method 100 thereafter returns to block B101.

Using the method 100 of FIG. 3 aboard the representative vehicles 12 of FIG. 1, the various rules and conditions sets normally applied manually in the back office server 14 are intelligently applied aboard the vehicle 12 by its ECU 16, working in concert with the back office server 14. This enables the ECU 16 to selectively autoconfigure or adapt to software code updates when such updates target previously masked software partitions and associated functions. The ECU 16 could also be aware of features and function capabilities, for instance by equipping the vehicle 12 with sensors, modules, options, subscription status, etc., before enabling. This could be accomplished with VIN mapping and table logic. The ECU 16 would create a confidence score for turning the functionality based on these conditions being met.

Among other potential benefits, the present approach enables enterprise level control across multiple vehicles and ECU-level masking of trouble indications. This also allows the classification of impacted vehicles 12 by a broad vehicle platform level down to specific trim levels, telematics hardware generation, software version, occurrence of live trouble codes, or individually by VIN, and to remediate false indications over-the-air. Implementing the present teachings may occur pre-sale, e.g., in plant, at dealerships or other locations with available cellular connectivity, or in transport to the dealer lot, to initiate remediation with a higher probability of successful resolution prior to the vehicle entering customer hands. Post-sale trigger points such as subscription state changes or live trouble code occurrence upload events may also be used with increased success due to the reliable cellular connection and telematics awake states.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A distributed network system, comprising:
a back office server having a first telematics network and a remote calibration tool; and
a population of host systems in wireless communication with the back office server, each respective host system of the population of host systems including a second telematics network, the second telematics network having:
an electronic control unit (ECU) operable for communicating remotely with the back office server; and
one or more devices controlled by corresponding software code;
wherein the back office server is configured, in response to a configuration signal, to transmit an over-the-air (OTA) software update to the ECU of a predetermined one or more of the host systems, and wherein the ECU is configured, in response to the OTA software update, to selectively mask or unmask a software partition of the corresponding software code to respectively disable or enable a function of the one or more devices.

2. The distributed network system of claim 1, wherein the ECU is configured, in response to the OTA software update, to temporarily disable a diagnostic trouble code (DTC) associated with the function of the one or more devices.

3. The distributed network system of claim 1, wherein the ECU is configured to determine a confidence score indicative of a likelihood of the OTA software update having corrected a fault in the corresponding software code, and to unmask the software partition when the confidence score exceeds a confidence threshold.

4. The distributed network system of claim 1, wherein the ECU is configured to compare a flag in the OTA software update to a flag in the software partition to determine whether the OTA update is directed to correcting a fault in the software partition, and to unmask the software partition when the flag in the OTA software update matches the flag in the software partition.

5. The distributed network system of claim 1, wherein the ECU is configured to selectively upload a set of host system updates to the back office, the set of host system updates including an updated status of the software partition.

6. The distributed network system of claim 1, wherein the back office server includes a graphical use interface (GUI) as part of the first telematics network, and wherein the remote calibration tool is accessible to a user of the back office server via the GUI.

7. The distributed network system of claim 1, wherein ECU is configured, in response to the OTA software update including an updated software version, to selectively unmask the software partition of the corresponding software code to enable the function of the one or more devices.

8. The distributed network system of claim 1, wherein the ECU of each respective host system is identically configured, and wherein the back office is configured to transmit the OTA software update to a subset of the host systems in the population of host systems based on the configuration signal.

9. A method for use with a distributed network system, the method comprising:
in response to a configuration signal, transmitting an over-the-air (OTA) software update to one or more of host systems via a first telematics network of a back office server; and
selectively disabling or enabling a function of a device of a host system in response to receipt of the OTA software update by the host system, including selectively masking or unmasking a software partition of a corresponding software code via an electronic control unit (ECU) of a second telematics network of the host system, the second telematics network being in wireless communication with the first telematics network of the back office server.

10. The method of claim 9, further comprising:
temporarily disabling a diagnostic trouble code (DTC) associated with the function of the one or more devices, via the ECU, in response to the OTA software update.

11. The method of claim 9, further comprising:
determining a confidence score, via the ECU, that is indicative of a likelihood of the OTA software update having corrected a fault in the corresponding software code; and
unmasking the software partition when the confidence score exceeds a confidence threshold.

12. The method of claim 9, further comprising:
comparing, via the ECU, a flag in the OTA software update to a flag in the software partition to determine whether the OTA update is directed to correcting a fault in the software partition; and
unmasking the software partition when the flag in the OTA software update matches the flag in the software partition.

13. The method of claim 9, further comprising:
selectively uploading a set of host system updates to the back office server via the ECU, the set of host system updates including an updated status of the software partition.

14. The method of claim 9, further comprising:
using a graphical use interface (GUI) of the back office server to access the first telematics network.

15. The method of claim 9, further comprising:
in response to the OTA software update including an updated software version, using the ECU to selectively unmask the software partition of the corresponding software code to enable the function of the one or more devices.

16. The method of claim 9, further comprising:
transmitting the OTA software update from the back office server to a subset of a population of host systems based on the configuration signal.

17. A vehicle in communication with a back office server in a distributed network, the vehicle comprising:
an electronic control unit (ECU) operable for communicating with the back office server via a telematics system of the vehicle; and
one or more vehicle devices controlled by corresponding software code, wherein the ECU is configured to:
receive an over-the-air (OTA) software update from the back office server via the telematics system; and
in response to the OTA software update from the back office server, selectively mask or unmask a software partition of the corresponding software code to respectively disable or enable a function of the one or more vehicle devices, including temporarily disabling or enabling a diagnostic trouble code (DTC) associated with the function of the one or more vehicle devices.

18. The vehicle of claim 17, wherein the ECU is configured to:
determine a confidence score indicative of a likelihood of the OTA software update having corrected a fault in the corresponding software code; and
unmask the software partition when the confidence score exceeds a confidence threshold.

19. The vehicle of claim 17, wherein the ECU is configured to:
compare a flag in the OTA software update to a flag in the software partition to determine whether the OTA update is directed to correcting a fault in the software partition; and
unmask the software partition when the flag in the OTA software update matches the flag in the software partition.

20. The vehicle of claim 17, wherein the ECU is configured to:
selectively upload a set of host system updates to the back office server, the set of host system updates including an updated status of the software partition.
